(19) United States
(12) Patent Application Publication
(10) Pub. No.: US 2008/0298965 A1
(43) Pub. Date: Dec. 4, 2008

(54) Wind Drum

(76) Inventor: Michael Alan Keena, Overland Park, KS (US)

Correspondence Address: Michael Alen Keena, 12221 Knox Street, Overland Park, KS, 66213, US

(21) Appl. No.: 12/116,000

(22) Filed: May 6, 2008

Related U.S. Application Data
(60) Provisional application No. 60/941,814, filed on Jun. 4, 2007.

(51) Int. Cl. F03D 7/06; F03D 3/06

(52) U.S. Cl. 416/41; 416/131; 416/223 R; 416/61

(57) ABSTRACT

The Wind Drum is a cylinder shaped wind utilization machine primarily used for electricity generation. Instead of a solid wall attaching the top and bottom circular plates are eight rods spaced equally around the circumference of the top and bottom circular plates. Now you have a drum shape you can see through from the elongated side. Attached to these rods are boards, or flat rectangular pieces, which make-up the vanes of the Wind Drum. Through mechanical manipulation of the angles of the eight vanes compared to the center, or pivotal spot, of the top and bottom circular plates the vanes are positioned so as to be pushed by wind energy, directing wind energy into other vanes of the Wind Drum, or to become neutral to wind energy allowing minimal resistance to wind energy. These changes of the wind vane angles allows for maximum efficiency in converting wind energy into mechanical energy.

### RELATED APPLICATIONS

The present application is a continuation application of U.S. provisional patent application Ser. No. 60/941,814, filed Jun. 4, 2007, for WIND DRUM FOR MORE EFFICIENT WIND UTILIZATION, by Michael Alan Keena, included by reference herein and for which benefit of the priority date is hereby claimed.

### FIELD OF THE INVENTION

The present invention relates to the utilization of wind for energy purposes and specifically to wind turbines and, more particularly, to an improved design of mounting and control of wind vanes.

### BACKGROUND OF THE INVENTION

Ever since Man felt the wind blow we have attempted to created machines to harness this source of energy. But wind is a fickle thing making it very hard to effectively harnessing this source of energy; different air density, consistency of speed or force, destructive capacities all make the taming of this resource difficult at best. To this day Man is still searching for more efficient ways to control wind energy for mechanical energy, primarily to create electricity for powering our ever demanding needs. Transferring wind energy into mechanical energy for creating electrical energy is still a very inefficient science. The machines in use today have many disadvantages and are wasteful in many aspects.

The oldest device to convert wind energy into mechanical energy is the windmill. This device looks much like an airplane propeller but with many ‘props’, or vanes, closely packed in a vertical plan attached to a central location which transfers the torque energy of the centrally turning pivot point of the rotating vanes to the desired mechanical purpose such as pumping water from the ground via gears or belts.

Today, it is believed the most efficient way of transferring wind energy into mechanical force or torque is the wind turbine. The wind turbine is classified as a device that looks much like an airplane propeller with generally three ‘props’, or vanes, which faces into the wind allowing the wind's force to turn the turbines vanes on a vertical plan around a central attachment location which transfers the torque into a horizontal plan along a shaft allowing for mechanical energy generation, generally used for creating electricity. The main difference between a windmill and a wind turbine is the number of vanes and the form and construction of the vanes; the vanes being designed closely to glider wings for the purposes of using that design's characteristics for lift.

An alternate design for a device to convert wind energy to mechanical energy is a drum type design. This design has its vanes fixed into circular plates top and bottom in the horizontal plan with the vanes length running in the vertical plan, looking much like a drum in general shape. The wind blows into the vanes which forces the top and bottom plates to rotate on the horizontal plan and with a shaft attached to the center of the circular plates this torque and be put to many uses, such as powering a generator for electricity. This design has great inefficacies in creating wind energy into mechanical energy and only a small part of the device is utilized for the conversion of energy. An alternate configuration of this design is to ‘lay’ the drum on its side having the end plates rotating on the vertical plan with the vanes fixed into the plates and running along the horizontal plan, but this configuration still has the same ineffectiveness.

Windmills have been used for centuries to convert wind energy into mechanical energy but they have been recognized as being highly ineffective in converting wind energy into mechanical energy for generating electricity. The design of their vanes and general design and construction are not economical for electricity generation.

To gain more conversion of the winds energy wind turbines such as put forth by U.S. Pat. No. 7,042,109 are the considered ‘standard’ machine for converting wind energy into mechanical energy. But these inventions have many inefficiencies. Today there are several turbine designs that can harness wind into mechanical energy, which in turn is used to create electrical energy, but they are fairly inefficient in many aspects: only converting small amounts of mechanical energy from wing energy, they are expensive to construct, they are expensive in the size of land area they must occupy for their meager utility, by their sheer size some consider them hideously ugly to the landscape, and finally they are hazardous to many elements of the environment.

There are many drum type inventions for the utilization of wind's energy as described in U.S. Pat. No. 3,895,882 but all of them only utilize one-fourth of the rotation circle exposed to the wind to create their mechanical energy. This one-fourth of rotation is the part of the rotation, or rotating circle if you were looking from the top down at a drum's end, that is most forward to the incoming wind and is to the point of the rotation circle ninety degrees down rotation from the most forward point of the rotation. This is the only point of impact of the current drum designs. The other three-fourths of the circle, or rotation circle of the vanes, is either a hindrance to converting the winds energy (namely the mirror side of the utilizing quarter which is part of the rotation circle ninety degrees up rotation from the wind's direction to the point of the rotation circle most forward into the wind) or is neutral neither creating or hindering energy conversion (the half of the rotation circle farthest from the wind's incoming direction and thus hidden by the utilizing quarter and hindrance quarter of the rotational circle). Even U.S. Pat. No. 3,895,882 tries to alleviate some of this by its wind directing arm (FIG. 1, Part 28) by trying to redirect the wind to the back part of the circle or rotation, but this design achieves minimal usage of the wind via this attempt. Currently patented drum type designs fail to effectively convert wind energy to mechanical energy because of this drawback, U.S. Pat. No. 4,004,861 even fails to achieve more than one-fourth rotational utilization with its vanes being positioned to shield the three-fourths rotation circle from the wind by manipulating the vanes position but it is still only accomplishing one-fourth of its rotation circle being active to the wind's energy.

Wind turbines function by having a few well designed vanes turning at high speeds to effectively convert wind energy into mechanical energy for electricity generation. These vanes turn at such speeds as to create great hazard to birds as the birds do not see the vanes as they turn. These devices can have horrible impact on local environments when installed.

All of these design types have general inefficiencies relating to the Wind Resistance Wave formed between the wind direction and the device. when wind is blowing it is much like water as it tries to find the path of least resistance, when a device is in its path wind will try and go through it or around it whichever is easiest. Windmills, wind turbines, and wind drums restrict the flow of wind as they convert wind energy into mechanical energy; this creates a Wind Resistance Wave in front of the device. This Wind Resistance Wave is a buffer of compressed air which redirects wind away or around the device much like water in a river flows around a rock in its path, thus reducing effectiveness of the device as ‘new’ wind is hindered or altered before reaching the device and being converted into mechanical energy.

Because of the way windmills, wind turbines, and wind drums convert wind energy into mechanical energy and their creation of Wind Resistance Waves great disturbances in wind flow are created not only to the front of the devices but also to the sides and behind the devices. This make them inefficient concerning spacing relative to other like devices. There must be large areas around each device because the turbulence and wind disturbance each device generates greatly hinders the wind flow around and behind them.

Present invention has at least the following advantages:

The Wind Drum minimizes or eliminates the Wind Resistance Wave which is generated up-wind side of other wind utilization machines because the wind is allowed to pass through the Wind Drum. The correct vane angles during the up-wind rotation maximize the usage of the wind force while at the same time allowing the wind to pass into the down-wind side of the Wind Drum. Because of the Wind Resistance Wave front being minimized more wind can flow into the Wind Drum's vanes and through the Wind Drum and thus allow more wind energy to be utilized into mechanical energy or torque. The adjusting angles of the Wind Drum vanes maximizes the utilization of wind energy while minimizing resistance when the wind's energy is not being converted to mechanical energy.

The Wind Drum gains more transfer of the wind's energy into mechanical energy because the wind vanes it utilizes present a greater area of frontage, or area facing the wind, for the wind to push against. A greater ratio of mechanical energy to wind energy is achieved because of this increased area of wind capture. This efficiency will allow for effective usage of wind in Wind Class 2 or 3 and higher.

The Wind Vanes angles during the horizontal rotation of the Wind Drum allows the wind to pass through the Wind Drum which in turn allows the down-wind part of the full rotation to transform wind energy to torque or mechanical energy. The angles of the Wind Vanes are designed to maximize transfer of wind energy to torque or mechanical energy or minimize wind resistance when wind energy cannot be transformed to torque or mechanical energy through the full rotation cycle. The Wind Vane angles allow the Wind Drum to be extremely effective in transforming wind energy into torque or mechanical energy in the lower Wind Class 2 category as well as higher categories.

Because the Wind Drum's height is usually greater than its width and because the wind is allowed to pass through the Wind Drum, the area of wind disturbance is much smaller then with wind turbine machines currently in use. Wind Drums can be set closer together both side-to-side and front-to-back (as well as stacked one on top of another). This requires far less land for deployment of multiple Wind Drums at desired locations while getting more utilization of the wind energy at these locations.

During the rotation of the Wind Drum's Wind Vanes in the horizontal plan the Wind Drum appears to be solid from just about all outside points of view as the Wind Vanes are presented to the wind for maximum capture of the wind's force. Because of this birds will be far less likely to fly into the Wind Drum and hurt themselves. Unlike wind turbines in use today, particularly for electrical generation, which have huge blades that rotation in the vertical plan, chopping through the air at speeds that make them hard to see and even harder to avoid by wildlife.

When climate conditions generate destructive wind forces the Wind Drum's design which allows wind to pass through the device would be less likely to be damaged then current wind turbine designs.

Because there is two ends to the Wind Drum there is also two torque generation rotational points. This allows for two locations, one at each end, to which torque/mechanical consuming systems can be positioned allowing for a much more balanced and effective utilization of the torque/mechanical energy.

### SUMMARY OF THE INVENTION

In accordance with the present invention, there is provided a wind utilization device which is far more efficient then currently patented devices. Picture a cylinder standing on one of its round ends. Instead of a solid wall attaching the top and bottom circular plates are eight rods spaced equally around the circumference of the top and bottom circular plates. Now you have a drum shape you can see through from the elongated side. Attached to these rods are boards, or flat rectangular pieces, of non-specific dimensions (the size and shape of these can vary depending on desired performance or surrounding environment) which make-up the vanes of the Wind Drum. Through mechanical manipulation of the angles of the eight vanes compared to the center, or pivotal spot, of the top and bottom circular plates the vanes are positioned so as to be pushed by wind energy, direct wind energy into other vanes of the Wind Drum, or to become neutral to wind energy allowing minimal resistance to wind energy. These changes of the vane angles allows for maximum efficiency in converting wind energy into mechanical energy.

The direction the Wind Drum is facing is important because the point which is farthest toward the winds incoming direction on the circular top and bottom plates is the beginning of the functional rotation and all the vanes angles are determined from this point in the rotation. One way to manage this facing direction can be done by a sweeping fin type shape on the top of the Wind Drum which will force the Wind Drums face towards the wind's incoming direction because its length extends from the center, or pivotal point, of the circular top and bottom plates so that when the wind blows it will hit this fin forcing it to a facing of least resistance, thus turning the Wind Drum's ‘face’ into the wind. Or small weather metering devices can be utilized along with computers and mechanical means of rotating the Wind Drum's ‘face’ into the wind can be used.

The manipulation of the vanes angles to the center, or pivotal, point of the top and bottom circular plates can be done by a channel at the top and bottom of the vanes where they connect to the top and bottom circular plates. The vanes have a central post which connect to the top and bottom circular plates and pins pointing in the same direction which are located at either end of the same edge as the center, attaching, post. These pins run in the channel and due to the distance between the channel and the center posts attachment location the angle of the vane is manipulated. Or they can be manipulated by radio/remote control mechanicals at the central connection point of the vane to the top or bottom circular plate, these radio/remote controlled systems will control the angle of the vanes and in themselves be controlled by a central system, such as a computer.

An alternate method of manipulating the vane angle is by a remote control process when in a computer is used to understand and control the vane angles within the rotation and using radio controlled motors or mechanics manipulates the vane angles.

The Wind Drum itself can be placed on tall tower like frames, or poles, to minimize wind turbulence from ground variations or objects.

Cone or domed shaped covers for the top and bottom circular plates can house the electronics and electrical generators or various other mechanical energy using systems.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of the top and bottom of a simple wind drum wind vane. This is not all-inclusive of the wind vane configurations, see FIG. 6 for alternative wind vane designs;

FIG. 2 is a top view of the vanes around the perimeter of the wind drum rotation and the manipulating channel showing the angle to center, or pivotal, point of the circular top plate. The circular top plate in which the vanes are attached to via the center attachment point is mirrored on the bottom by the circular bottom plate. The manipulation channel is also duplicated at the bottom. The number and angles of the vanes in this figure are not definitive as the number and angles of the vanes may vary depending on the environment the wind drum is planned for;

FIG. 3 is a front view of a front view of the wind drum which is the side facing the wind; the view is as the wind would blow into the wind drum;

FIG. 4 is a right view of a side view of a wind drum showing the device set on a tower construction. Displayed is also the top and bottom covers in a cone shape which is where the housing of the mechanical energy using systems such as electrical generators would be located. Also the wind fin can be seen attached to the top cover;

FIG. 8 is a front cutaway view of a wind drum's top portion showing how the top circular plate, top cover, angle manipulation channel, center support structure, two wind vanes, and electrical generators;

FIG. 5 is a top view of an alternative method for manipulating the vanes angles with remote controlled mechanical servos which are controlled by a central control unit;

FIG. 6 is a top view of an alternative vane form which resembles the shape of airplane wings and an alternative central structure post; and

FIG. 7 is a top view of an alternative designs of support structures for the wind drum.

For purposes of clarity and brevity, like elements and components will bear the same designations and numbering throughout the Figures.

### DESCRIPTION OF THE PREFERRED EMBODIMENT

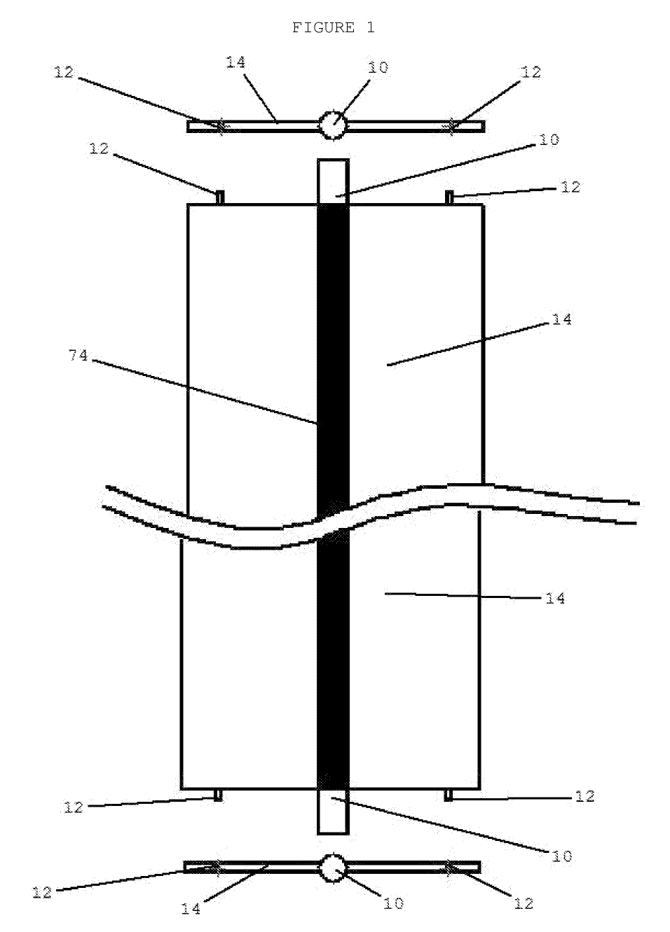

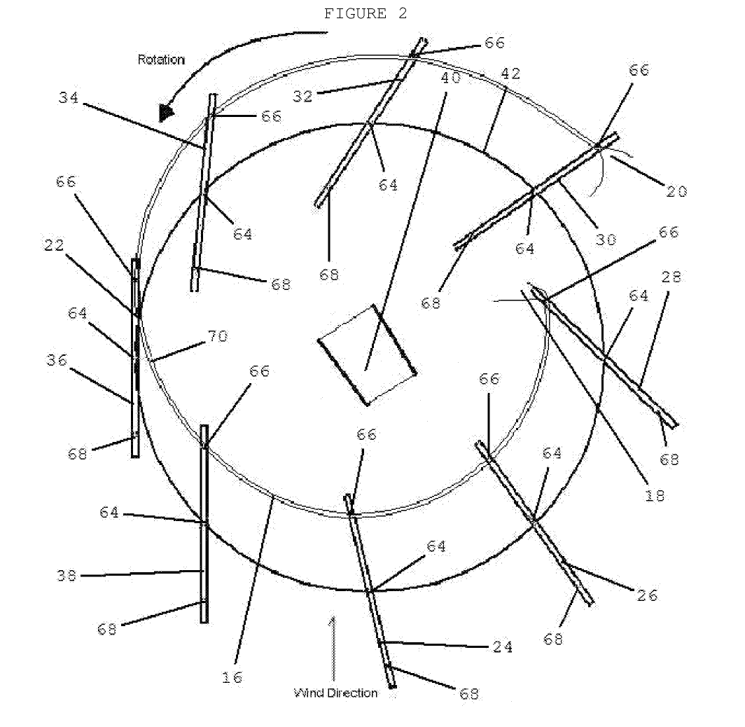

FIG. 1 is a detail view of the wind vane, top and bottom ends 14 of a simple Wind Drum wind vane. This is not all-inclusive of the wind vane configurations, see FIG. 6 for alternative wind vane designs. The main purpose of the wind vane is to create resistance to the wind's energy. As the wind vanes resist the blowing wind the top and bottom circular plates they are attached to via the center attachment posts, top and bottom 10, are forced to rotate on a central axis thus converting wind energy into torque energy which can then be used for mechanical energy. End posts, top and bottom 12, are utilized to manipulate the angle of the wind vane in comparison to the direction of the wind by riding in a channel placed at the top and bottom. This allows for maximum facing into the wind's oncoming direction of the wind vane's broad, flat side for maximum conversion of wind energy into mechanical energy, or to manipulate the wind vane to such an angle that wind is directed in an angle to the backside of the Wind Drum, or to manipulate the wind vane so that the thin, side of the wind vane is facing into the wind and thus minimizing resistance to the wind's energy. The wind vane central backbone 74 is the integral part of the Wind Drum which rigidly attaches the top circular plate 42 and bottom circular plate 48 together through the center attachment posts, top and bottom 10.

FIG. 2 is a top view of a top down view of the vanes around the perimeter of the wind drum rotation (as they are attached to the outer edge of the top circular plate 42) and the top angle manipulation channel 16 showing the angle to center, or pivotal, point of the top circular plate 42. The top circular plate 42 in which the vanes are attached to via the center attachment posts is mirrored on the bottom by the circular bottom plate. The top angle manipulation channel 16 is also duplicated at the bottom. The number and angles of the vanes in this figure are not comprehensive as the number and angles of the vanes may vary depending on the environment the wind drum is planned for. The top angle manipulation channel 16 controls the angle of the wind vanes by altering the distance between the wind vane end posts and the same wind vane's center attachment post and by either trailing or leading in the rotation of the Wind Drum as can be seen in FIG. 2 at the eight wind vane positions shown. The top angle manipulation channel 16 also allows for the exchanging of the wind vane end posts from one end to the other via the sender channel disconnector 18 which releases the end post currently riding in the top angle manipulation channel 16 and the receiver channel connector 20 which receives and positions the new wind vane end post into the top angle manipulation channel 16 allowing for continuation of wind vane top angle manipulation maximizing wind energy conversion. The top angle manipulation channel 16 is located just under the top circular plate 42 and just above the bottom circular plate 48 and will be made of metal rails to either side of the desired channel location. Because of the location of the top angle manipulation channel 16 a pass through gap 22 will be required to allow for the wind vanes center attachment posts to pass through the top angle manipulation channel 16 allowing wind vanes and top and bottom circular plates to fully rotate through wind conversion cycle. The end post pass through gap 70 is for the purpose of allowing the non-engaged end post to pass through the manipulation channel while still retaining control of the engaged end post. The center support structure 40 shown in FIG. 2 is not a comprehensive representation of the structure for supporting the Wind Drum; please see FIG. 7 for alternate designs. The bottom design and construction of the circular plate, top angle manipulation channel 16, pass through gap 22, and wind vanes is a mirror to the top as shown in this FIG. 2. The eight wind drum vanes can be seen at eight position in FIG. 2 starting at wind vane (closest to the wind) 24 which is the start of the Wind Drum rotational cycle and going counter-clockwise in the direction of rotation next is wind vane (within forward utilization quarter) 26, wind vane (farthest point to wind's right) 28, wind vane (within rear utilization quarter) 30, wind vane (farthest from the wind) 32, wind vane (within rear hindrance quarter) 34, wind vane (farthest point to wind's left) 36, wind vane (within forward hindrance quarter) 38. The wind vane angles shown in FIG. 2 at the eight displayed positions are not comprehensive, other angles of wind vanes maybe more efficient depending on the environmental conditions the Wind Drum is to be placed into. The rotation of the Wind Drum is broken into four quarters which represent the effectiveness of wind vanes within the quarters, or slices of the rotational ‘pie’. Starting with the circular plate's point which is farthest into the wind from the circle's center and going counter-clockwise to the circular plate's point which is farthest to the left if you had you were facing into the wind this quarter section is referred to as the utilizing quarter. The part of the rotational circle that spans from the circular plate's farthest left point to a point which is farthest from the on-coming wind on the circular plate is called the rear utilizing quarter. The section between the point on the circular plate which is farthest from the on-coming wind and the point on the circular plate farthest right if you had you were facing into the wind is the rear hindrance quarter. And the section which spans between the point on the circular plate which is farthest right to the point which is farthest into the wind from the circle's center is called the hindrance quarter. The wind vane angles within these quarters, or slices, of the rotational pie are designed to maximize the utilization of the winds force which allows for the most efficient conversion of the wind's force into mechanical energy. FIG. 2 shows how the top center attachment post 64 of each wind vane is attached to the outside edge of the top circular plate 42 and how the top end post (channel engaged) 66 rides in the top angle manipulation channel 16 and alters the angle of the wind vane because of the changing distance between the top end post (channel engaged) 66 and the top center attachment post 64. The top end post (not channel engaged) 68 is also seen in FIG. 2, showing how it is not engaged to or with anything and thus not hindering the end post (channel engaged) manipulation of the wind vane angle.

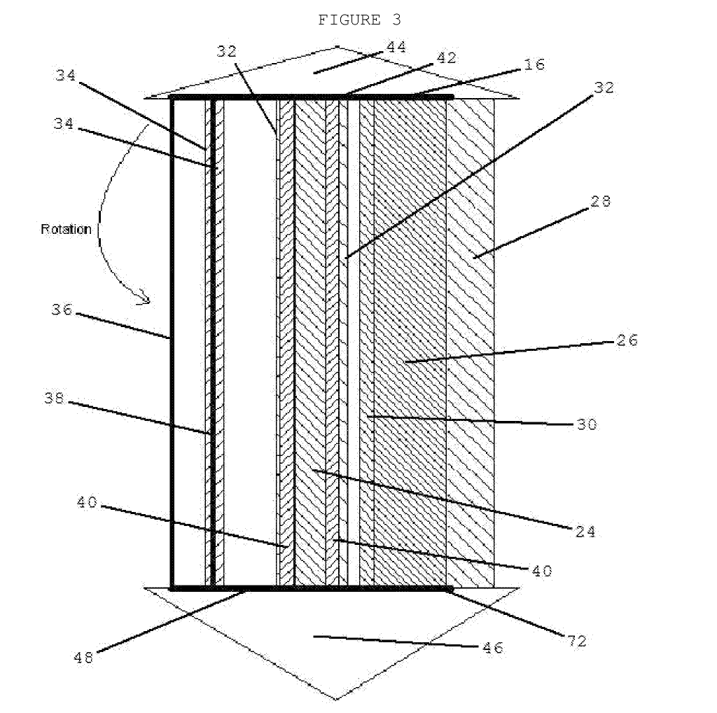

FIG. 3 is a front view of the Wind Drum as it is facing into the wind. FIG. 3 gives another perspective of the wind vanes and their angle to the on-coming wind. All eight wind vanes can be seen in this figure starting with wind vane (closest to the wind) 24, and working in the direction of the Wind Drum's rotational cycle you can see wind vane (within forward utilization quarter) 26, wind vane (farthest point to wind's right) 28, wind vane (within rear utilization quarter) 30, wind vane (farthest from the wind) 32, wind vane (within rear hindrance quarter) 34, wind vane (farthest point to wind's left) 36, wind vane (within forward hindrance quarter) 38. FIG. 3 is a good view showing the wind vanes and their area of facing the wind's energy. The center support structure 40 can also be seen as it also helps redirect wind energy to backside of the Wind Drum. The top cover 44 and bottom cover 46 are also displayed in FIG. 3, both of which are attached to the central support structure and would house electrical generators or other torque/mechanical energy consuming systems.

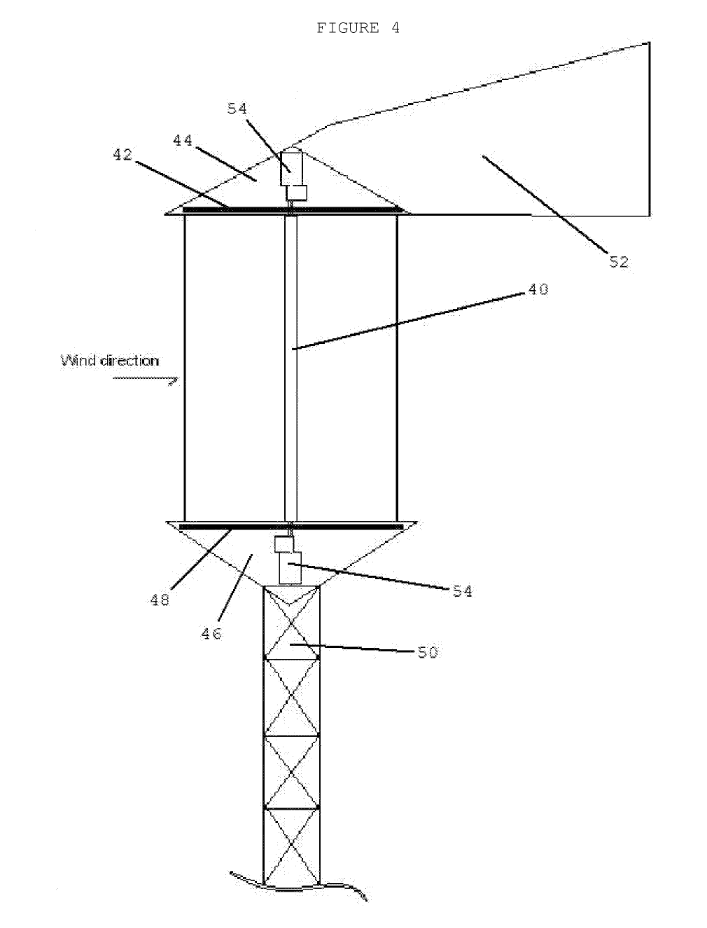

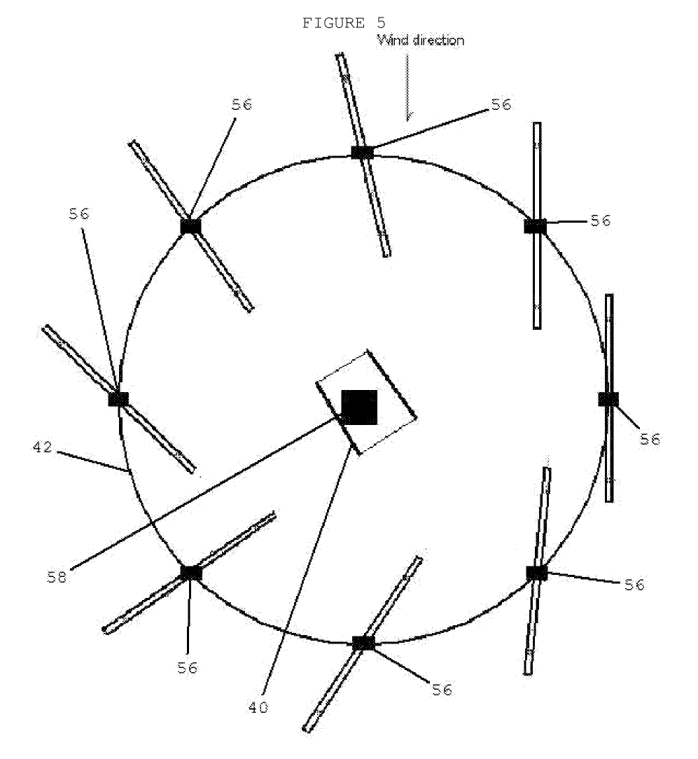

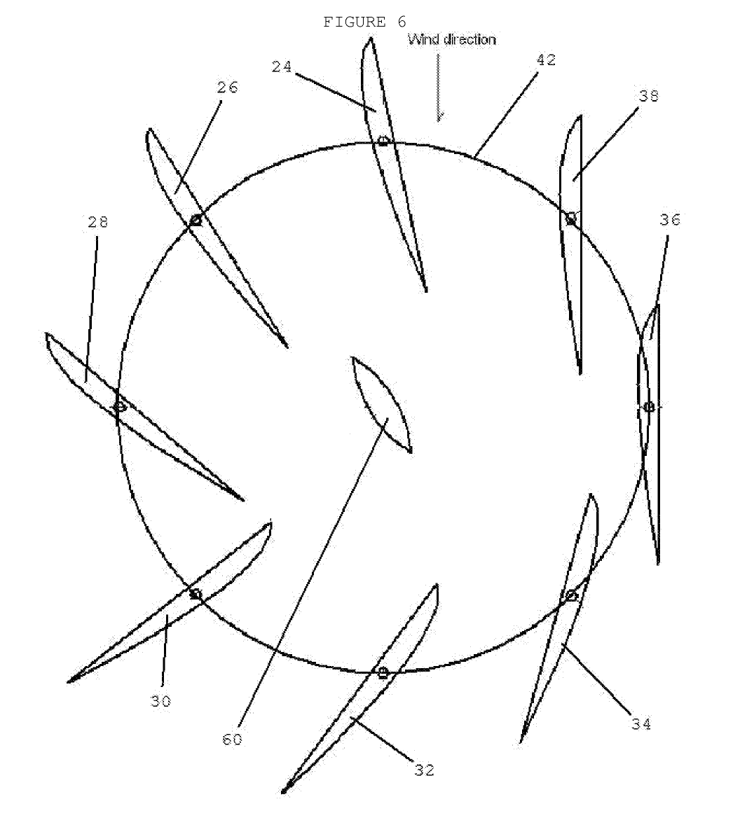

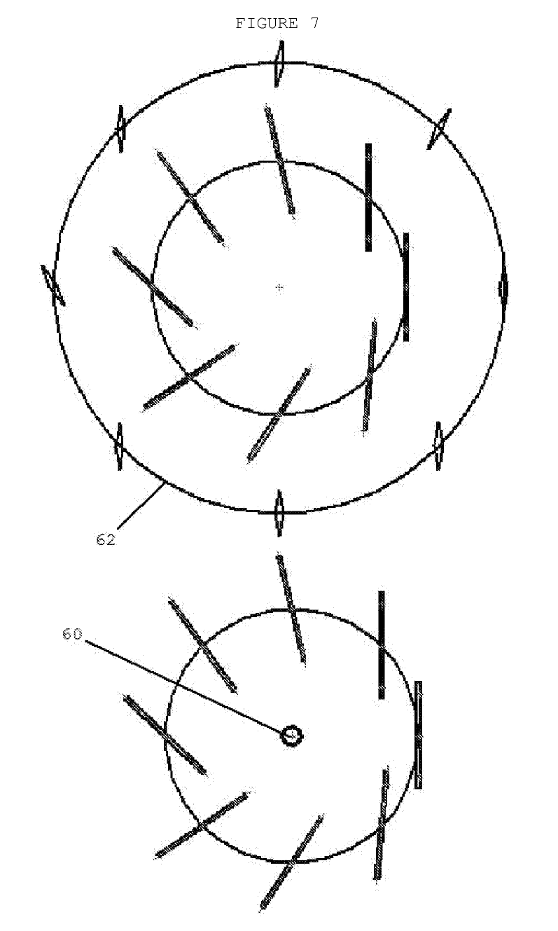

FIG. 4 is a side view of a wind drum showing the device set on a structural tower 50 comprised of a typical bar, or beam, frame construction. In FIG. 4 the wind fin 52 can be seen, this design is not conclusive as there are many type of designs that do the function of turning wind devices into the wind; the various designs and their effectiveness is a product of the environment where the device is to reside in. Displayed is also the top cover 44 and bottom cover 46 in a cone shape which allows enough room to house torque/mechanical energy consuming devices such as an electric generator 54. As FIG. 4 shows, two electric generators can be utilized, one at either end of the torque providing pivoting points as can be seen in FIG. 4, this allows for far more efficient, balanced use of the torque. The wind vanes are not shown in this figure allowing visualization of the center support structure 40 running through the center of the wind vane rotating ‘drum’ area and being attached to the top circular plate 42 and bottom circular plate 48 supporting both plates as they rotation around this central attachment point.

FIG. 5 which is a top view of the alternative method for manipulating the vanes angles with vane remote control servos 56 which are controlled by a central remote controller 58 unit. This alternative to the mechanical version of controlling wind vane angles to the wind using the angle manipulation channels would not require wind vanes to have end posts, top and bottom 12 nor the top angle manipulation channel 16 or the bottom angle manipulation channel 72. Instead a controlling computer system would determine the direction of the on-coming wind and control the various wind vanes via the central remote controller 58 sending appropriate radio signals out to the vane remote control servos 56 telling them to manipulate the wind vanes to the proper angles for their position in the Wind Drum rotation and the wind direction.

FIG. 6 is a top down view of the alternative wind vane form. This alternative design resembles the shape of airplane wings, which using this design for certain environments could be more effective in converting wind energy into torque energy because of the lift the airplane wing design creates on the curved side of the devices. This potential lift could be very beneficial in some circumstances. Also in FIG. 6 a center support structure alternate design 60 of a double edge blade type design can be seen.

FIG. 7 which is a top view of two alternative designs of support structures for the Wind Drum. A center support structure alternate design 60 can be seen as a round, pole type design. The outside support structure alternate design 62 could be utilized to allow for no restricting elements in the center of the Wind Drum while also assisting in directing the wind energy into the Wind Drum's wind vane rotational area.

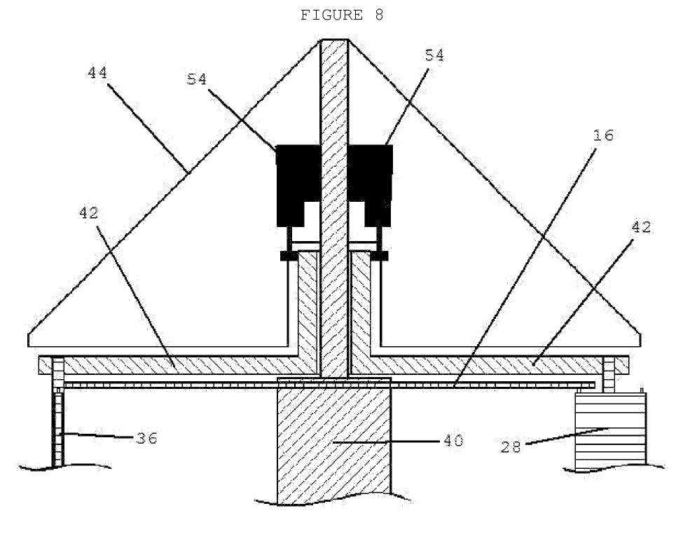

FIG. 8 which is a front cutaway view of the Wind Drum's top portion showing how the top circular plate 42, top cover 44, top angle manipulation channel 16, center support structure 40, two wind vanes, and electric generators. Might not have been described. FIG. 8 shows how the top circular plate 42, top cover 44, and central support structure interact with each other allowing the top circular plate 42 full, free-floating rotation around the center point. This is mirrored on the bottom of the Wind Drum and is also simply attached in a non-specific manner to the structural tower 50 of a height determined to be best for the environment the Wind Drum is to be placed into.

In Operation the Wind Drum is placed on top of a structural tower 50 of a pre-determined height for the environment the Wind Drum is to be located in. The bottom cover 46 and center support structure 40 are rigidly connected to this tower. The top cover 44 is rigidly connected to the center support structure 40 at its top end in such a manner that it can swivel as a unit with center support structure 40, top angle manipulation channel 16, bottom angle manipulation channel 72, and bottom cover 46. This unit of elements comprises the facing of the Wind Drum and is turned into the oncoming wind by the wind fin 52. The wind vanes are attached to the top circular plate 42 and bottom circular plate 48 in a manner which allows for the wind vanes to swivel on the center attachment posts, top and bottom 10 while also rigidly attaching the top circular plate 42 and bottom circular plate 48 in a manner that makes a solid drum type device composed of the two round end pieces (top circular plate 42 and bottom circular plate 48) and the eight wind vane central backbone 74 elements.

The top angle manipulation channel 16 and the bottom angle channel are mirrors of each other and keep the tops and bottoms of the wind vanes at the same angles to the oncoming wind. The top angle manipulation channel 16 and bottom manipulation channel are tweaked, or design, can be tweaked for maximizing the individual wind vane angles for the environment and wind conditions the Wind Drum is going to be placed into by molding the two side rails that compose the angle manipulation channels. The distance that the engaged end post is manipulated within the angle manipulation channels from the center attachment post and whether it is leading or trailing the center attachment post determines the angle of the wind vane to the oncoming wind as shown in FIG. 2. The key to the Wind Drum's effectiveness is that wind vanes positional angle in comparison to the wind's in-coming direction and allowing the wind to pass through the front part of the Wind Drum being directed to back part of the Wind Drum and the wind vanes in that area of the Wind Drum which are also properly angle to take further advantage of the wind's energy.

The wind pressure on the wind vanes which are angled to create resistance to the wind generate rotational pressure on the top circular plate 42 and bottom circular plate 48 because the wind vanes opposite these resisting wind vanes are angled to minimize resistance and all wind vanes are attached to the outer edge of the circular plates while the plates themselves are attached centrally to a point at which they can rotate around. This rotational energy or torque is transmitted up and down into the top cover 44 or bottom cover 46 thus to be consumed by electric generators or other torque/mechanical energy consumers.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A wind drum for more efficient wind utilization, comprising:
means for attaching the wind vane to the top/bottom circular plates;
means for sliding through the manipulation channel both at the top and bottom, being just under the top circular plate and just above the bottom circular plate for allowing the changing of the angle at which the wind vane faces the incoming wind;
means for utilizing the wind energy by maximizing the resistance surface facing the wind during the rotation cycle which is creating mechanical energy from wind energy while minimizing resistance surface facing the wind during the rotation cycle which is a hindrance in converting wind energy into mechanical energy, rigidly connected to said means for sliding through the manipulation channel both at the top and bottom, being just under the top circular plate and just above the bottom circular plate for allowing the changing of the angle at which the wind vane faces the incoming wind, and rigidly connected to said means for attaching the wind vane to the top/bottom circular plates;
means for controlling the distance between the vane end points and that same vanes center attachment point by varying the distance between the channel itself and the center attachment point for that same vane, thus changing the angle of the vane, slidingly engaged to said means for sliding through the manipulation channel both at the top and bottom, being just under the top circular plate and just above the bottom circular plate for allowing the changing of the angle at which the wind vane faces the incoming wind;
means for releasing the control from one end post, the one currently controlled within the angle manipulation channel, so that the other end post it can be manipulated within the channel. The angle manipulation channel opens up here in an angle forcing the other end post to swing around and engage the receiver channel connecter, rigidly connected to said means for controlling the distance between the vane end points and that same vanes center attachment point by varying the distance between the channel itself and the center attachment point for that same vane, thus changing the angle of the vane;
means for engaging the vanes end post which is not currently being manipulated by the angle manipulation channel and channeling it into the angle manipulation channel and thus becoming the currently manipulated end post, rigidly connected to said means for controlling the distance between the vane end points and that same vanes center attachment point by varying the distance between the channel itself and the center attachment point for that same vane, thus changing the angle of the vane;
means for allowing the center attachment posts to pass through the angle manipulation channel while not losing control of the vane end posts, rigidly connected to said means for controlling the distance between the vane end points and that same vanes center attachment point by varying the distance between the channel itself and the center attachment point for that same vane, thus changing the angle of the vane;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is closest to the wind's direction along the circular plate and is the starting point of the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the forward utilization quarter, where the maximum wind force comes to bear, of the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is at the furthest point to the wind's right of the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the rear utilization quarter, where the wind force is redirected and continued to being utilized, of the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is farthest from the wind within the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the rear hindrance quarter of the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is at the farthest point to wind's left of the wind drum's rotation;
means for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the forward hindrance quarter of the wind drum's rotation;
means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation, rigidly connected to said means for controlling the distance between the vane end points and that same vanes center attachment point by varying the distance between the channel itself and the center attachment point for that same vane, thus changing the angle of the vane;
means for holding the vanes in place via their center attachment posts while rotating on a central connection point to the rest of the wind drum's structure, pivotally connected to said means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation, and swivelly connected to said means for attaching the wind vane to the top/bottom circular plates;
means for housing the systems which will consume the mechanical energy generated by the wind drum, such as electrical generators, rigidly connected to said means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation;
means for housing the systems which will consume the mechanical energy generated by the wind drum, such as electrical generators, rigidly connected to said means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation;
means for holding the vanes in place via their center attachment posts while rotating on a central connection point to the rest of the wind drum's structure, pivotally connected to said means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation, and swivelly connected to said means for attaching the wind vane to the top/bottom circular plates;
means for manipulating the vane angle to the wind being controlled or directed by a remote control system via radio signals;
means for calculating the proper vane angles given weather/wind information gathered via weather devices and sending radio signals to the vane remote control servos so that they will properly adjust the angle of the vanes during the wind drum's rotation;
means for supporting the top structure of the wind drum and thus connecting the bottom to the top. The vanes rotate around this center support structure. This design is a solid pole;
means for supporting the top structure of the wind drum and thus connecting the bottom to the top. The vanes rotate inside this support structure;
means for attaching the wind vane to the top circular plates;
means for sliding through the manipulation channel both at the top, being just under the top circular plate for allowing the changing of the angle at which the wind vane faces the incoming wind;
means for being disengaged from the angle manipulation channel while the other end post opposite this end post is riding in the angle manipulation channel. This end post will eventually swap function with its opposite, top end post channel engaged;
means for allowing the not engaged end posts to pass through the angle manipulation channel while not losing control of the vane engaged end posts, rigidly connected to said means for controlling the distance between the vane end points and that same vanes center attachment point by varying the distance between the channel itself and the center attachment point for that same vane, thus changing the angle of the vane;
means for controlling the distance between the vane end points and that same vanes center attachment point by varying the distance between the channel itself and the center attachment point for that same vane, thus changing the angle of the vane, rigidly connected to said means for allowing the not engaged end posts to pass through the angle manipulation channel while not losing control of the vane engaged end posts, rigidly connected to said means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation, rigidly connected to said means for allowing the center attachment posts to pass through the angle manipulation channel while not losing control of the vane end posts, rigidly connected to said means for engaging the vanes end post which is not currently being manipulated by the angle manipulation channel and channeling it into the angle manipulation channel and thus becoming the currently manipulated end post, rigidly connected to said means for releasing the control from one end post, the one currently controlled within the angle manipulation channel, so that the other end post it can be manipulated within the channel. The angle manipulation channel opens up here in an angle forcing the other end post to swing around and engage the receiver channel connecter, and slidingly engaged to said means for sliding through the manipulation channel both at the top and bottom, being just under the top circular plate and just above the bottom circular plate for allowing the changing of the angle at which the wind vane faces the incoming wind; and
means for rigidly attaching the top and bottom circular plates in a manner that allows the wind vanes to pivot but at the same time keep the top and bottom circular plates rigidly in sync, just like the wall of a barrel would do. This ridge wind vane backbone is firmly attached to the end posts, top and bottom, rigidly inside to said means for utilizing the wind energy by maximizing the resistance surface facing the wind during the rotation cycle which is creating mechanical energy from wind energy while minimizing resistance surface facing the wind during the rotation cycle which is a hindrance in converting wind energy into mechanical energy.

2. The wind drum in accordance with claim 1, wherein said means for attaching the wind vane to the top/bottom circular plates comprises a post, center of top/bottom edge center attachment posts, top and bottom.

3. The wind drum in accordance with claim 1, wherein said means for sliding through the manipulation channel both at the top and bottom, being just under the top circular plate and just above the bottom circular plate for allowing the changing of the angle at which the wind vane faces the incoming wind comprises a metal, strong, ridge end posts, top and bottom.

4. The wind drum in accordance with claim 1, wherein said means for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation comprises a metal, strong, rectangular, box shaped with front and back ends open, allows wind to pass through, rigid center support structure.

5. The wind drum in accordance with claim 1, wherein said means for holding the vanes in place via their center attachment posts while rotating on a central connection point to the rest of the wind drum's structure comprises a metal, strong, rigid, rotates on its center top circular plate.

6. The wind drum in accordance with claim 1, wherein said means for housing the systems which will consume the mechanical energy generated by the wind drum, such as electrical generators comprises a hollow, metal, strong, rigid top cover.

7. The wind drum in accordance with claim 1, wherein said means for housing the systems which will consume the mechanical energy generated by the wind drum, such as electrical generators comprises a metal, hollow, strong, rigid bottom cover.

8. The wind drum in accordance with claim 1, wherein said means for holding the vanes in place via their center attachment posts while rotating on a central connection point to the rest of the wind drum's structure comprises a metal, strong, ridge bottom circular plate.

9. The wind drum in accordance with claim 1, wherein said means for attaching the wind vane to the top circular plates comprises a metal, strong, ridge top center attachment post.

10. The wind drum in accordance with claim 1, wherein said means for sliding through the manipulation channel both at the top, being just under the top circular plate for allowing the changing of the angle at which the wind vane faces the incoming wind comprises a metal, strong, ridge top end post (channel engaged).

11. The wind drum in accordance with claim 1, wherein said means for being disengaged from the angle manipulation channel while the other end post opposite this end post is riding in the angle manipulation channel. This end post will eventually swap function with its opposite, top end post channel engaged comprises a metal, strong, ridge top end post (not channel engaged).

12. The wind drum in accordance with claim 1, wherein said means for allowing the not engaged end posts to pass through the angle manipulation channel while not losing control of the vane engaged end posts comprises a metal, smooth, ridge, strong end post pass through gap.

13. The wind drum in accordance with claim 1, wherein said means for controlling the distance between the vane end points and that same vanes center attachment point by varying the distance between the channel itself and the center attachment point for that same vane, thus changing the angle of the vane comprises a metal, strong, smooth, ridge bottom angle manipulation channel.

14. The wind drum in accordance with claim 1, wherein said means for rigidly attaching the top and bottom circular plates in a manner that allows the wind vanes to pivot but at the same time keep the top and bottom circular plates rigidly in sync, just like the wall of a barrel would do. This ridge wind vane backbone is firmly attached to the end posts, top and bottom comprises a metal, strong, rigid wind vane central backbone.

15. A wind drum for more efficient wind utilization, comprising:
a post, center of top/bottom edge center attachment posts, top and bottom, for attaching the wind vane to the top/bottom circular plates;
a metal, strong, ridge end posts, top and bottom, for sliding through the manipulation channel both at the top and bottom, being just under the top circular plate and just above the bottom circular plate for allowing the changing of the angle at which the wind vane faces the incoming wind;
a light weight, rectangle, thin edged wind vane, top and bottom ends, for utilizing the wind energy by maximizing the resistance surface facing the wind during the rotation cycle which is creating mechanical energy from wind energy while minimizing resistance surface facing the wind during the rotation cycle which is a hindrance in converting wind energy into mechanical energy, rigidly connected to said end posts, top and bottom, and rigidly connected to said center attachment posts, top and bottom;
a metal, smooth channel, ridge, strong top angle manipulation channel, for controlling the distance between the vane end points and that same vanes center attachment point by varying the distance between the channel itself and the center attachment point for that same vane, thus changing the angle of the vane, slidingly engaged to said end posts, top and bottom;
a metal, smooth, rigid, strong sender channel disconnector, for releasing the control from one end post, the one currently controlled within the angle manipulation channel, so that the other end post it can be manipulated within the channel. The angle manipulation channel opens up here in an angle forcing the other end post to swing around and engage the receiver channel connecter, rigidly connected to said top angle manipulation channel;
a metal, smooth, rigid, strong receiver channel connector, for engaging the vanes end post which is not currently being manipulated by the angle manipulation channel and channeling it into the angle manipulation channel and thus becoming the currently manipulated end post, rigidly connected to said top angle manipulation channel;
a metal, smooth, ridge, strong pass through gap, for allowing the center attachment posts to pass through the angle manipulation channel while not losing control of the vane end posts, rigidly connected to said top angle manipulation channel;
a metal or plastic, strong, board-like in dimensions, light weight wind vane (closest to the wind), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is closest to the wind's direction along the circular plate and is the starting point of the wind drum's rotation;
a metal or plastic, strong, board-like in dimensions, light weight wind vane (within forward utilization quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the forward utilization quarter, where the maximum wind force comes to bear, of the wind drum's rotation;
a metal or plastic, strong, board-like in dimensions, light weight wind vane (farthest point to wind's right), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is at the furthest point to the wind's right of the wind drum's rotation;
a metal or plastic, strong, board-like dimensions, light weight wind vane (within rear utilization quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the rear utilization quarter, where the wind force is redirected and continued to being utilized, of the wind drum's rotation;
a metal or plastic, strong, board-like dimensions, light weight wind vane (farthest from the wind), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is farthest from the wind within the wind drum's rotation;
a metal or plastic, strong, board-like dimensions, light weight wind vane (within rear hindrance quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the rear hindrance quarter of the wind drum's rotation;
a metal or plastic, strong, board-like dimensions, light weight wind vane (farthest point to wind's left), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is at the farthest point to wind's left of the wind drum's rotation;
a metal or plastic, strong, board-like dimensions, light weight wind vane (within forward hindrance quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the forward hindrance quarter of the wind drum's rotation;
a metal, strong, rectangular, box shaped with front and back ends open, allows wind to pass through, rigid center support structure, for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation, rigidly connected to said top angle manipulation channel;
a metal, strong, rigid, rotates on its center top circular plate, for holding the vanes in place via their center attachment posts while rotating on a central connection point to the rest of the wind drum's structure, pivotally connected to said center support structure, and swivelly connected to said center attachment posts, top and bottom;
a hollow, metal, strong, rigid top cover, for housing the systems which will consume the mechanical energy generated by the wind drum, such as electrical generators, rigidly connected to said center support structure;
a metal, hollow, strong, rigid bottom cover, for housing the systems which will consume the mechanical energy generated by the wind drum, such as electrical generators, rigidly connected to said center support structure;
a metal, strong, ridge bottom circular plate, for holding the vanes in place via their center attachment posts while rotating on a central connection point to the rest of the wind drum's structure, pivotally connected to said center support structure, and swivelly connected to said center attachment posts, top and bottom;
an electronic, radio controlled, strong vane remote control servos, for manipulating the vane angle to the wind being controlled or directed by a remote control system via radio signals;
a computer electronics, radio sender central remote controller, for calculating the proper vane angles given weather/wind information gathered via weather devices and sending radio signals to the vane remote control servos so that they will properly adjust the angle of the vanes during the wind drum's rotation;
a metal, strong, rigid center support structure alternate design, for supporting the top structure of the wind drum and thus connecting the bottom to the top. The vanes rotate around this center support structure. This design is a solid pole;
a metal, strong, rigid outside support structure alternate design, for supporting the top structure of the wind drum and thus connecting the bottom to the top. The vanes rotate inside this support structure;
a metal, strong, ridge top center attachment post, for attaching the wind vane to the top circular plates;
a metal, strong, ridge top end post (channel engaged), for sliding through the manipulation channel both at the top, being just under the top circular plate for allowing the changing of the angle at which the wind vane faces the incoming wind;
a metal, strong, ridge top end post (not channel engaged), for being disengaged from the angle manipulation channel while the other end post opposite this end post is riding in the angle manipulation channel. This end post will eventually swap function with its opposite, top end post channel engaged;
a metal, smooth, ridge, strong end post pass through gap, for allowing the not engaged end posts to pass through the angle manipulation channel while not losing control of the vane engaged end posts, rigidly connected to said top angle manipulation channel;
a metal, strong, smooth, ridge bottom angle manipulation channel, for controlling the distance between the vane end points and that same vanes center attachment point by varying the distance between the channel itself and the center attachment point for that same vane, thus changing the angle of the vane, rigidly connected to said end post pass through gap, rigidly connected to said center support structure, rigidly connected to said pass through gap, rigidly connected to said receiver channel connector, rigidly connected to said sender channel disconnector, and slidingly engaged to said end posts, top and bottom; and
a metal, strong, rigid wind vane central backbone, for rigidly attaching the top and bottom circular plates in a manner that allows the wind vanes to pivot but at the same time keep the top and bottom circular plates rigidly in sync, just like the wall of a barrel would do. This ridge wind vane backbone is firmly attached to the end posts, top and bottom, rigidly inside to said wind vane, top and bottom ends.

16. The wind drum as recited in claim 15, further comprising:
a metal or plastic, rigid, light weight wind fin, for aligning the wind drum's face into the wind's on-coming direction so that the vane angles during the rotation are correct for maximum wind energy conversion to mechanical energy. alternatives to this wind fin are electronic and mechanical systems which ‘read’ the wind direction via weather devices mounted on top of the wind drum and control the facing of the wind drum using that information as direction, rigidly connected to said top cover.

17. The wind drum as recited in claim 15, wherein said wind vane, top and bottom ends is metal.

18. The wind drum as recited in claim 16, wherein said wind vane, top and bottom ends is metal.

19. A wind drum for more efficient wind utilization, comprising:
a post, center of top/bottom edge center attachment posts, top and bottom, for attaching the wind vane to the top/bottom circular plates;
a metal, strong, ridge end posts, top and bottom, for sliding through the manipulation channel both at the top and bottom, being just under the top circular plate and just above the bottom circular plate for allowing the changing of the angle at which the wind vane faces the incoming wind;
a light weight, rectangle, thin edged, metal wind vane, top and bottom ends, for utilizing the wind energy by maximizing the resistance surface facing the wind during the rotation cycle which is creating mechanical energy from wind energy while minimizing resistance surface facing the wind during the rotation cycle which is a hindrance in converting wind energy into mechanical energy, rigidly connected to said end posts, top and bottom, and rigidly connected to said center attachment posts, top and bottom;
a metal, smooth channel, ridge, strong top angle manipulation channel, for controlling the distance between the vane end points and that same vanes center attachment point by varying the distance between the channel itself and the center attachment point for that same vane, thus changing the angle of the vane, slidingly engaged to said end posts, top and bottom;
a metal, smooth, rigid, strong sender channel disconnector, for releasing the control from one end post, the one currently controlled within the angle manipulation channel, so that the other end post it can be manipulated within the channel. The angle manipulation channel opens up here in an angle forcing the other end post to swing around and engage the receiver channel connecter, rigidly connected to said top angle manipulation channel;
a metal, smooth, rigid, strong receiver channel connector, for engaging the vanes end post which is not currently being manipulated by the angle manipulation channel and channeling it into the angle manipulation channel and thus becoming the currently manipulated end post, rigidly connected to said top angle manipulation channel;
a metal, smooth, ridge, strong pass through gap, for allowing the center attachment posts to pass through the angle manipulation channel while not losing control of the vane end posts, rigidly connected to said top angle manipulation channel;
a metal or plastic, strong, board-like in dimensions, light weight wind vane (closest to the wind), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is closest to the wind's direction along the circular plate and is the starting point of the wind drum's rotation;
a metal or plastic, strong, board-like in dimensions, light weight wind vane (within forward utilization quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the forward utilization quarter, where the maximum wind force comes to bear, of the wind drum's rotation;
a metal or plastic, strong, board-like in dimensions, light weight wind vane (farthest point to wind's right), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is at the furthest point to the wind's right of the wind drum's rotation;
a metal or plastic, strong, board-like dimensions, light weight wind vane (within rear utilization quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the rear utilization quarter, where the wind force is redirected and continued to being utilized, of the wind drum's rotation;
a metal or plastic, strong, board-like dimensions, light weight wind vane (farthest from the wind), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is farthest from the wind within the wind drum's rotation;
a metal or plastic, strong, board-like dimensions, light weight wind vane (within rear hindrance quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the rear hindrance quarter of the wind drum's rotation;
a metal or plastic, strong, board-like dimensions, light weight wind vane (farthest point to wind's left), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is at the farthest point to wind's left of the wind drum's rotation;
a metal or plastic, strong, board-like dimensions, light weight wind vane (within forward hindrance quarter), for creating resistance to the winds force and directing the wind force into certain directions allowing for the rotation of the wind drum around a center point thus creating torque which in turn creates mechanical energy. wind vanes are manipulated so that their angle to the wind's on-coming direction maximizes the utilization of the wind's energy. This wind vane is within the forward hindrance quarter of the wind drum's rotation;
a metal, strong, rectangular, box shaped with front and back ends open, allows wind to pass through, rigid center support structure, for supporting the top structure of the wind drum and thus connecting the bottom to the top. The vanes rotate around this center support structure. The center support structure is rectangular box shaped with the front and back side open allowing wind to pass through it and be directed to the back portion of the wind drum rotation, rigidly connected to said top angle manipulation channel;
a metal, strong, rigid, rotates on its center top circular plate, for holding the vanes in place via their center attachment posts while rotating on a central connection point to the rest of the wind drum's structure, pivotally connected to said center support structure, and swivelly connected to said center attachment posts, top and bottom;
a hollow, metal, strong, rigid top cover, for housing the systems which will consume the mechanical energy generated by the wind drum, such as electrical generators, rigidly connected to said center support structure;
a metal, hollow, strong, rigid bottom cover, for housing the systems which will consume the mechanical energy generated by the wind drum, such as electrical generators, rigidly connected to said center support structure;
a metal, strong, ridge bottom circular plate, for holding the vanes in place via their center attachment posts while rotating on a central connection point to the rest of the wind drum's structure, pivotally connected to said center support structure, and swivelly connected to said center attachment posts, top and bottom;
a metal or plastic, rigid, light weight wind fin, for aligning the wind drum's face into the wind's on-coming direction so that the vane angles during the rotation are correct for maximum wind energy conversion to mechanical energy. alternatives to this wind fin are electronic and mechanical systems which ‘read’ the wind direction via weather devices mounted on top of the wind drum and control the facing of the wind drum using that information as direction, rigidly connected to said top cover;
an electronic, radio controlled, strong vane remote control servos, for manipulating the vane angle to the wind being controlled or directed by a remote control system via radio signals;
a computer electronics, radio sender central remote controller, for calculating the proper vane angles given weather/wind information gathered via weather devices and sending radio signals to the vane remote control servos so that they will properly adjust the angle of the vanes during the wind drum's rotation;
a metal, strong, rigid center support structure alternate design, for supporting the top structure of the wind drum and thus connecting the bottom to the top. The vanes rotate around this center support structure. This design is a solid pole;
a metal, strong, rigid outside support structure alternate design, for supporting the top structure of the wind drum and thus connecting the bottom to the top. The vanes rotate inside this support structure;
a metal, strong, ridge top center attachment post, for attaching the wind vane to the top circular plates;
a metal, strong, ridge top end post (channel engaged), for sliding through the manipulation channel both at the top, being just under the top circular plate for allowing the changing of the angle at which the wind vane faces the incoming wind;
a metal, strong, ridge top end post (not channel engaged), for being disengaged from the angle manipulation channel while the other end post opposite this end post is riding in the angle manipulation channel. This end post will eventually swap function with its opposite, top end post channel engaged;
a metal, smooth, ridge, strong end post pass through gap, for allowing the not engaged end posts to pass through the angle manipulation channel while not losing control of the vane engaged end posts, rigidly connected to said top angle manipulation channel;
a metal, strong, smooth, ridge bottom angle manipulation channel, for controlling the distance between the vane end points and that same vanes center attachment point by varying the distance between the channel itself and the center attachment point for that same vane, thus changing the angle of the vane, rigidly connected to said end post pass through gap, rigidly connected to said center support structure, rigidly connected to said pass through gap, rigidly connected to said receiver channel connector, rigidly connected to said sender channel disconnector, and slidingly engaged to said end posts, top and bottom; and
a metal, strong, rigid wind vane central backbone, for rigidly attaching the top and bottom circular plates in a manner that allows the wind vanes to pivot but at the same time keep the top and bottom circular plates rigidly in sync, just like the wall of a barrel would do. This ridge wind vane backbone is firmly attached to the end posts, top and bottom, rigidly inside to said wind vane, top and bottom ends.
